(19) United States
(12) Patent Application Publication
(10) Pub. No.: US 2024/0201354 A1
(43) Pub. Date: Jun. 20, 2024

(54) SIGNAL PROCESSING DEVICE, ULTRASONIC SYSTEM, AND VEHICLE

(71) Applicant: Rohm Co., Ltd., Kyoto (JP)

(72) Inventor: Takahiro Tsuboi, Kyoto (JP)

(21) Appl. No.: 18/431,611

(22) Filed: Feb. 2, 2024

Related U.S. Application Data
(63) Continuation of application No. PCT/JP2022/025243, filed on Jun. 24, 2022.

(30) Foreign Application Priority Data
Aug. 4, 2021 (JP) 2021-128043

(51) Int. Cl. G01S 7/536; G01S 15/32; G01S 15/931

(52) U.S. Cl. CPC G01S 7/536; G01S 15/325; G01S 15/931

(57) ABSTRACT

A signal processing device includes a wave-transmission signal generator configured to generate a wave-transmission signal for wave transmission of an ultrasonic wave, a wave-reception signal output unit configured to output a wave-reception signal based on wave reception of an ultrasonic wave, and an own-wave recognition unit configured to recognize an own wave which is a reflected wave of the wave transmission that may be included in the wave reception. The wave-transmission signal generator is configured to generate the wave-transmission signal with a modulation pattern based on a true random number or a pseudo random number. The number of sections of the wave-transmission signal for each of which a frequency modulation pattern is individually settable in a time series is smaller than the number of bits of the true random number or the pseudo random number.

### CROSS-REFERENCE TO RELATED APPLICATIONS

This nonprovisional application is a continuation application of International Patent Application No. PCT/JP2022/025243 filed on Jun. 24, 2022, which claims priority Japanese Patent Application No. 2021-128043 filed in Japan on Aug. 4, 2021, the entire contents of which are hereby incorporated by reference.

### BACKGROUND OF THE INVENTION

### 1. Technical Field

The invention disclosed herein relates to a signal processing device that processes a wave-transmission signal that is for wave transmission of an ultrasonic wave and a wave-reception signal that is based on wave reception of an ultrasonic wave, an ultrasonic system including the signal processing device, and a vehicle including the ultrasonic system.

### 2. Description of Related Art

Conventionally, there is known an ultrasonic system that determines a distance to an obstacle by generating an ultrasonic wave and measuring a TOF (Time Of Flight) taken until a reflected wave of the ultrasonic wave returns. Such an ultrasonic system is often installed in a vehicle, and one of its known examples is a clearance sonar for use in a vehicle.

### BRIEF DESCRIPTION OF THE DRAWINGS

FIG. 1 is a diagram schematically showing a vehicle in which an ultrasonic system according to an embodiment is installed and a target object.

FIG. 2 is a diagram showing a configuration of the ultrasonic system according to the embodiment.

FIG. 3 is a diagram schematically showing an example of a waveform of a wave-transmission signal.

FIG. 4 is a diagram showing an example of a relationship between a pseudo random number and modulation targets.

FIG. 5 is a diagram showing an example of a relationship between first to fourth bits of the pseudo random number and content of frequency modulation performed on first and second burst signals.

FIG. 6 is a diagram showing an example of a relationship between fifth to eighth bits of the pseudo random number and the length of an interval time.

FIG. 7 is a diagram showing an example of a relationship between ninth to twelfth bits of the pseudo random number and the number of waves of the first burst signal.

FIG. 8 is a diagram showing an example of a relationship between thirteenth to sixteenth bits of the pseudo random number and the number of waves of the second burst signal.

### DESCRIPTION OF EMBODIMENTS

Hereinafter, an embodiment will be described with reference to the accompanying drawings. Note that an ultrasonic system according to the embodiment described below is designed to be installed in a vehicle as an example, and can be used for an alarm function, an automatic braking function, an automatic parking function, and the like, which are achieved by measuring a distance between the vehicle and a target object.

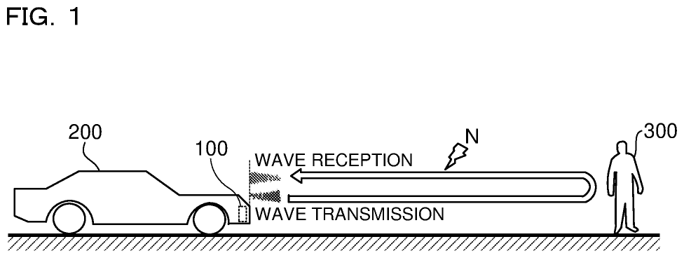

FIG. 1 shows a vehicle 200 having installed therein an ultrasonic system 100 (hereinafter, referred to as “the ultrasonic systems 100”) according to the embodiment, and a target object (an obstacle) 300. An ultrasonic wave transmitted from the ultrasonic system 100 is reflected from the target object 300 to be received as a reflected wave by the ultrasonic system 100. At this time, the ultrasonic system 100 also receives environmental noise N. The environmental noise N includes, for example, an ultrasonic wave transmitted from an ultrasonic system other than the ultrasonic system 100.

Hence, in the ultrasonic system 100, if its own wave, which is the reflected wave described above, is not correctly distinguished from the environmental noise N, the ultrasonic system 100 will erroneously detect a distance to the target object 300.

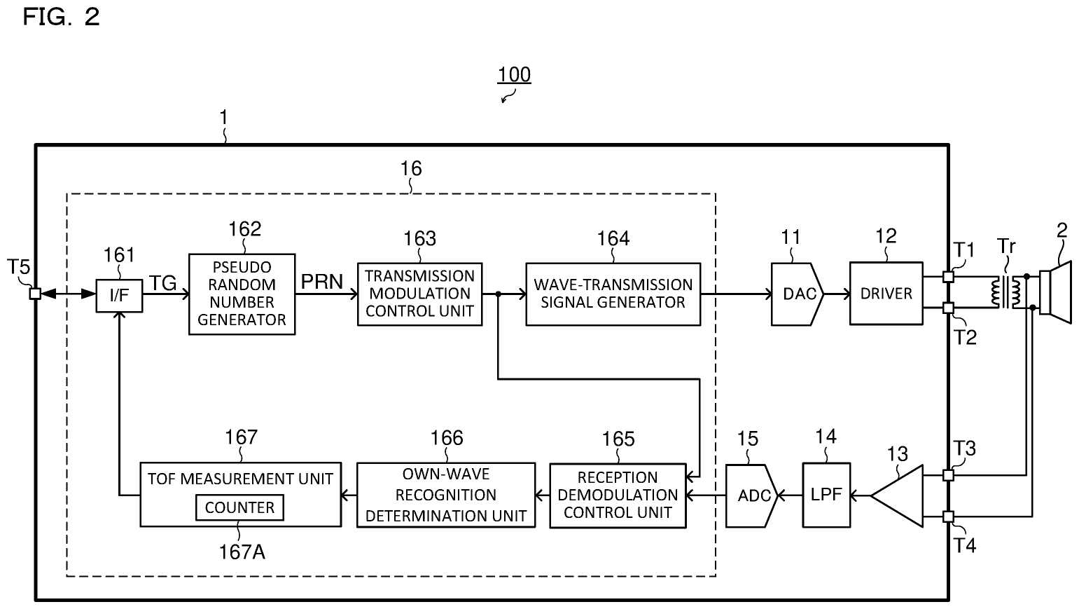

Next, the ultrasonic system 100 will be described. FIG. 2 is a diagram showing a configuration of the ultrasonic system 100.

The ultrasonic system 100 includes a signal processing device 1, a transformer Tr, and an ultrasonic transmission reception device 2. The ultrasonic transmission reception device 2 is externally connected to the signal processing device 1 via the transformer Tr. Note that the transformer Tr is not necessarily essential.

The signal processing device 1 is a semiconductor integrated circuit device. The signal processing device 1 includes a DAC (Digital to Analog Converter) 11, a driver 12, an LNA (Low Noise Amplifier) 13, an LPF (Low Pass Filter) 14, an ADC (Analog to Digital Converter) 15, a digital processing unit 16, and external terminals T1 to T5.

The DAC 11 performs digital-to-analog conversion on a wave-transmission signal output from a wave-transmission signal generator 164 included in the digital processing unit 16, and outputs the resulting signal to the driver 12.

A pair of differential output terminals of the driver 12 are connected to a primary side of the transformer Tr via the external terminals T1 and T2. To a secondary side of the transformer Tr, the ultrasonic transmission reception device 2 is connected. The driver 12, based on an output signal of the DAC 11, drives the ultrasonic transmission reception device 2.

The ultrasonic transmission reception device 2 includes an unillustrated piezoelectric element, and transmits and receives an ultrasonic wave. That is, the ultrasonic transmission reception device 2 functions both as a sound source and as a receiver.

A pair of differential input terminals of the LNA 13 are connected to the secondary side of the transformer Tr via the external terminals T3 and T4. An output signal of the LNA 13 is fed via the LPF 14 to the ADC 15. The ADC 15 performs analog-to-digital conversion on the output signal of the LNA 13, and outputs a signal resulting from the analog-to-digital conversion to a reception demodulation control unit 165 included in the digital processing unit 16.

The LNA 13, the LPF 14, and the ADC 15 are an example of a wave-reception signal output unit configured to output a wave-reception signal based on wave reception of an ultrasonic wave.

The digital processing unit 16 includes an interface 161, a pseudo random number generator 162, a transmission modulation control unit 163, the wave-transmission signal generator 164, the reception demodulation control unit 165, an own-wave recognition determination unit 166, and a TOF measurement unit 167.

The interface 161 is compliant with LIN (Local Interconnect Network) as an example, and performs communication via the external terminal T5 with an unillustrated ECU (Electronic Control Unit) installed in the vehicle 200 (see FIG. 1).

The interface 161, based on a transmission command from the ECU, outputs an update trigger signal TG to the pseudo random number generator 162. The interface 161 may be configured to output the update trigger signal TG every time it receives the transmission command, or may be configured to output the update trigger signal TG once every time it has received the transmission command N times (N is a natural number equal to or larger than 2).

The pseudo random number generator 162 generates a pseudo random number PRN, and outputs the pseudo random number PRN to the transmission modulation control unit 163. Further, the pseudo random number generator 162 updates the pseudo random number PRN every time it receives the update trigger signal TG.

As the pseudo random number generator 162, for example, an LFSR (Linear Feedback Shift Register) can be used. Since an LFSR has a simple configuration, by using an LFSR as the pseudo random number generator 162, it is possible to reduce the cost of the pseudo random number generator 162.

Since LFSRs are designed to perform the same operation if they have the same initial value, it is desirable for LFSRs of individual ultrasonic systems 100 to have different initial values. To achieve this, it is suitable to use, as the initial value of LFSR, part of a unique identification number (a serial number) assigned to the signal processing device 1. The number of patterns of a numerical part of a unique identification number assigned to the signal processing device 1 is presumably larger than the number of patterns of the value of the LFSR, and hence, as the initial value of the LFSR, part of the unique identification number assigned to the signal processing device 1 is used. Since part of each of unique identification numbers is used, there might be a case where initial values of individual ultrasonic systems 100 are not entirely different from each other. However, by using part of the unique identification numbers assigned to the signal processing devices 1, it is possible to easily increase dispersion of initial values of LFSRs among individual ultrasonic systems 100 (individual signal processing devices 1).

Instead of the pseudo random number generator 162, an analog true random number generator can be used. However, in the ultrasonic system 100, a random number is used not for security but for ensuring randomness of the modulation method, and hence, if a true random number generator is used, the randomness of a random number will be more than necessary, and the random number generator will be a factor to increase the cost of the signal processing device 1. In short, by using not a true random number generator but a pseudo random number generator, cost reduction can be achieved.

The transmission modulation control unit 163 determines a modulation pattern based on a pseudo random number. Targets of modulation with the modulation pattern include, for example, the frequency of the wave-transmission signal, the phase of the wave-transmission signal, the amplitude of the wave-transmission signal, the number of waves of a burst signal included in the wave-transmission signal, the interval time between a plurality of burst signals included in the wave-transmission signal, etc.

It is desirable that the modulation pattern determined by the transmission modulation control unit 163 be configured by combining a plurality of modulation targets. This facilitates ensuring randomness of the modulation method even in a case where the modulation range of each modulation target is narrow due to performance of the signal processing device 1 and the like.

Here, a description will be given by taking, as an example, a case where the pseudo random number generator 162 generates the pseudo random number PRN having 16 bits.

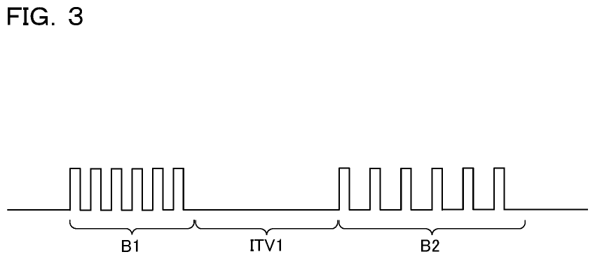

FIG. 3 is a diagram schematically showing an example of the waveform of the wave-transmission signal. The wave-transmission signal shown in FIG. 3 includes a first burst signal B1 and a second burst signal B2. Between the first burst signal B1 and the second burst signal B2, an interval time ITV1 is provided.

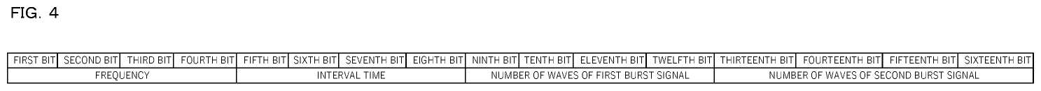

FIG. 4 is a diagram showing an example of a relationship between the pseudo random number PRN and modulation targets. In the example shown in FIG. 4, the transmission modulation control unit 163 determines, based on the first to fourth bits of the pseudo random number PRN, content of frequency modulation performed on the first burst signal B1 and the second burst signal B2. Further, in the example shown in FIG. 4, the transmission modulation control unit 163 determines, based on the fifth to eighth bits of the pseudo random number PRN, the length of the interval time ITV1. Further, in the example shown in FIG. 4, the transmission modulation control unit 163 determines, based on the ninth to twelfth bits of the pseudo random number PRN, the number of waves of the first burst signal B1. Further, in the example shown in FIG. 4, the transmission modulation control unit 163 determines, based on the thirteenth to sixteenth bits of the pseudo random number PRN, the number of waves of the second burst signal B2.

In the example shown in FIG. 4, the number of sections (two sections) of the wave-transmission signal for each of which a frequency modulation pattern is individually settable in a time series is smaller than the number of bits (16 bits) of the pseudo random number PRN. As a result, unlike the ultrasonic system disclosed in WO2020/004609 (paragraphs [0105] through [0118]), the signal processing device 1 is capable of ensuring sufficient randomness of the modulation method without generating a trade-off between the length of the wave-transmission signal and the number of pseudo random number generators 162.

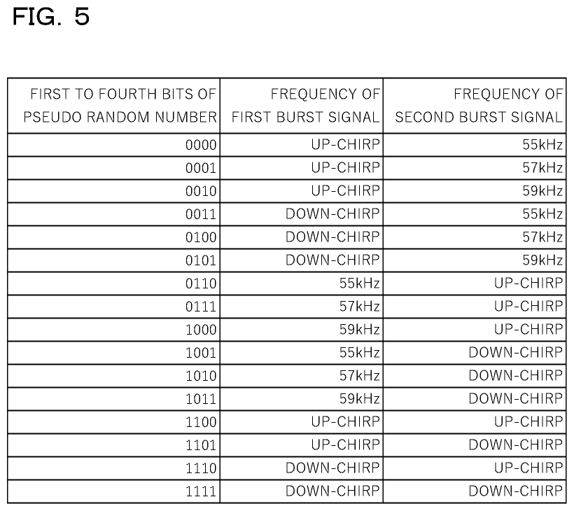

FIG. 5 is a diagram showing an example of a relationship between the first to fourth bits of the pseudo random number PRN and content of the frequency modulation performed on the first burst signal B1 and the second burst signal B2.

Note that, in a case where the first burst signal B1 has an up-chirp frequency and the second burst signal B2 has a fixed frequency, it is suitable that the maximum frequency of the first burst signal B1 be set equal to the frequency of the second burst signal B2. Further, in a case where the first burst signal B1 has a down-chirp frequency and the second burst signal B2 has a fixed frequency, it is suitable that the minimum frequency of the first burst signal B1 be set equal to the frequency of the second burst signal B2.

Further, in a case where the first burst signal B1 has a fixed frequency and the second burst signal B2 has an up-chirp frequency, it is suitable that the frequency of the first burst signal B1 be set equal to the minimum frequency of the second burst signal B2. Further, in a case where the first burst signal B1 has a fixed frequency and the second burst signal B2 has a down-chirp frequency, it is suitable that the frequency of the first burst signal B1 be set equal to the maximum frequency of the second burst signal B2.

Further, in a case where the first burst signal B1 has an up-chirp or a down-chirp frequency and the second burst signal B2 has an up-chirp or a down-chirp frequency, it is suitable that the last frequency of the first burst signal B1 be set equal to the first frequency of the second burst signal B2 at the start.

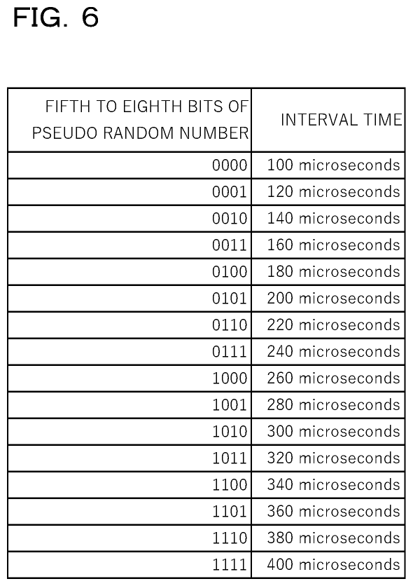

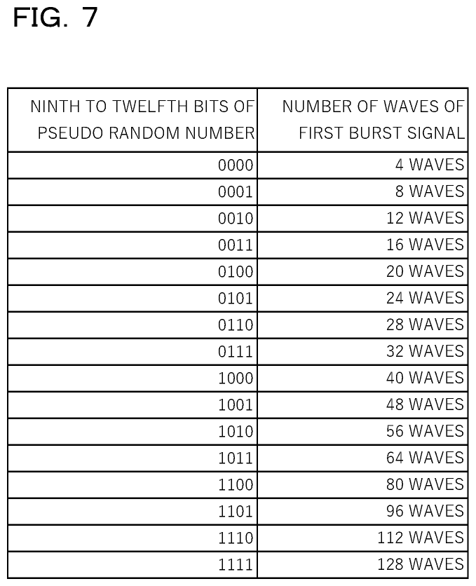

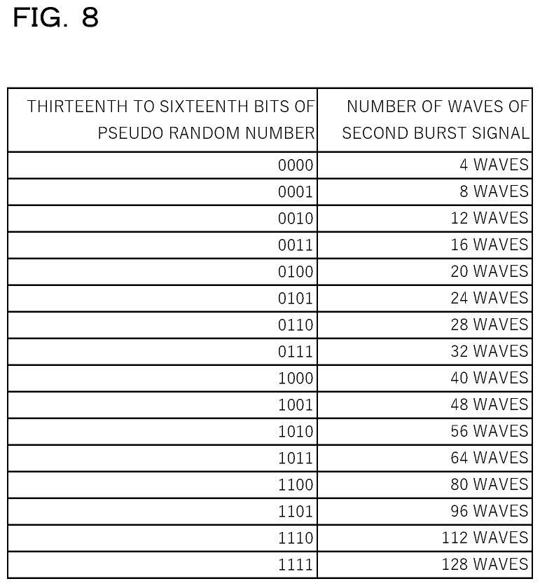

FIG. 6 is a diagram showing an example of a relationship between the fifth to eighth bits of the pseudo random number PRN and the length of the interval time ITV1. FIG. 7 is a diagram showing an example of a relationship between the ninth to twelfth bits of the pseudo random number PRN and the number of waves of the first burst signal B1. FIG. 8 is a diagram showing an example of a relationship between the thirteenth to sixteenth bits of the pseudo random number PRN and the number of waves of the second burst signal B2.

The wave-transmission signal generator 164 generates a wave-transmission signal having a modulation pattern determined by the transmission modulation control unit 163, that is, a modulation pattern that is based on the pseudo random number PRN. Thereby, randomness of the modulation method is ensured to make it possible to reduce the probability of the modulation method of an own ultrasonic system matching the modulation methods of other ultrasonic systems, and this contributes to improving the accuracy of recognition performed by the own-wave recognition determination unit 166.

The reception demodulation control unit 165 acquires the wave-reception signal output from the ADC 15 and information of the modulation pattern determined by the transmission modulation control unit 163. The reception demodulation control unit 165 determines, based on the modulation pattern, content of demodulation of the wave-reception signal.

In a case where, for example, frequency modulation is included in the modulation pattern, the reception demodulation control unit 165, by using correlation-convolution integral processing of the wave-transmission signal and the wave-reception signal, FFT (Fast Fourier Transform) processing with respect to the wave-reception signal, etc., demodulates information of the frequency modulation included in the wave-reception signal. In a case where, for example, the interval time is included in the modulation pattern, the reception demodulation control unit 165, by using processing of measuring time between adjacent peaks of the wave-reception signal, and the like, demodulates information of the interval time included in the wave-reception signal.

The own-wave recognition determination unit 166 recognizes an own wave based on the information of the modulation pattern determined by the transmission modulation control unit 163 and the information demodulated by the reception demodulation control unit 165. More specifically, the own-wave recognition determination unit 166 detects a reflected wave (an own wave) of the wave transmission if the level of similarity of the information of the modulation pattern determined by the transmission modulation control unit 163 with the information demodulated by the reception demodulation control unit 165 is equal to or higher than a predetermined level.

Note that the own-wave recognition determination unit 166 may recognize an own wave by integrating a plurality of wave-reception signals. Thereby, even in a case where, despite the randomness of the modulation method, in one execution of the wave transmission, the modulation method in the ultrasonic system 100 and the modulation method in an ultrasonic system other than the ultrasonic system 100 unfortunately match each other, the own-wave recognition determination unit 166 can correctly recognize an own wave unless the matching between the modulation methods is continuous. In short, by the own-wave recognition determination unit 166 recognizing an own wave by integrating a plurality of wave-reception signals, the accuracy of own-wave recognition can be further improved.

The TOF measurement unit 167 uses a counter 167A to count a time (a TOF) from when an ultrasonic wave is transmitted until when a reflected wave of the ultrasonic wave reflected from the target object 300 is received.

The TOF measurement unit 167 starts the counting by means of the counter 167A at a timing when a transmission command is transmitted from the ECU to the signal processing device 1.

When the own-wave recognition determination unit 166 has detected an own wave, the TOF measurement unit 167 holds a count value of the counter 167A at that timing. The count value held by the TOF measurement unit 167 is in accordance with the TOF, and the distance to the target object can be determined based on the TOF and the velocity of the ultrasonic wave transmitted from the ultrasonic transmission reception device. The count value held by the TOF measurement unit 167 is transmitted by the interface 161 to the ECU.

In addition to the embodiment described above, the configuration of the present disclosure can be modified in many different forms without departing from the scope of the present disclosure. It should be understood that the foregoing embodiment is not limitative but illustrative in every respect. The technical scope of the present invention is not determined by the foregoing embodiment but by the claims, and should be construed to include all modifications equivalent in meaning and scope to the claims.

As described above, a signal processing device (1) includes a wave-transmission signal generator (164) configured to generate a wave-transmission signal for wave transmission of an ultrasonic wave, a wave-reception signal output unit (13, 14, 15) configured to output a wave-reception signal based on wave reception of an ultrasonic wave, and an own-wave recognition unit (166) configured to recognize an own wave which is a reflected wave of the wave transmission that may be included in the wave reception. Here, the wave-transmission signal generator is configured to generate the wave-transmission signal with a modulation pattern based on a true random number or a pseudo random number, and the number of segments of the wave-transmission signal for each of which a frequency modulation pattern is individually settable in a time series is smaller than the number of bits of the true random number or the pseudo random number (a first configuration).

The signal processing device having the above first configuration is capable of accurately recognizing its own wave. Further, the signal processing device having the above first configuration is capable of ensuring sufficient randomness of a modulation method without generating a trade-off between the length of the wave-transmission signal and the number of devices that generate a true random number or a pseudo random number.

In the signal processing device having the above first configuration, the wave-transmission signal generator may be configured to generate the wave-transmission signal with a modulation pattern based on the pseudo random number (a second configuration).

In the signal processing device having the above second configuration, cost can be reduced to less than it would be with a configuration where a true random number is used.

The signal processing device having the above second configuration may further include an LFSR configured to generate the pseudo random number (a third configuration).

In the signal processing device having the above third configuration, the cost of a circuit that generates a pseudo random number can be reduced.

In the signal processing device having the above third configuration, an initial value of the LFSR may be part of a unique identification number assigned to the signal processing device (a fourth configuration).

With the signal processing device having the above fourth configuration, it is possible to easily increase dispersion of initial values of LFSRs among individual signal processing devices.

In the signal processing device according to any one of the above first to fourth configurations, the modulation pattern may be configured by combining a plurality of modulation targets (a fifth configuration).

In the signal processing device having the above fifth configuration, even in a case where the modulation range of each modulation target is narrow due to performance of the signal processing device 1 and the like, randomness of the modulation method can be easily ensured.

In the signal processing device according to any one of the above first to fifth configurations, the own-wave recognition unit may be configured to recognize the own wave by integrating a plurality of the wave-reception signals (a sixth configuration).

The signal processing device having the above sixth configuration is capable of recognizing the own wave with further improved accuracy.

As described far above, an ultrasonic system (100) includes the signal processing device having any one of the above first to sixth configurations and an ultrasonic transmission reception device (2) configured to be directly or indirectly connected to the signal processing device (a seventh configuration).

The ultrasonic system having the above seventh configuration is capable of accurately recognizing its own wave. Further, the ultrasonic system having the above seventh configuration is capable of ensuring sufficient randomness of the modulation method without generating a trade-off between the length of the wave-transmission signal and the number of devices that generate a true random number or a pseudo random number.

As described far above, a vehicle (200) includes the ultrasonic system having the above seventh configuration (an eighth configuration).

The vehicle having the above eighth configuration is capable of accurately recognizing its own wave. Further, the vehicle having the above eighth configuration is capable of ensuring sufficient randomness of the modulation method without generating a trade-off between the length of the wave-transmission signal and the number of devices that generate a true random number or a pseudo random number.

What is claimed is:

1. A signal processing device, comprising:
a wave-transmission signal generator configured to generate a wave-transmission signal for wave transmission of an ultrasonic wave;
a wave-reception signal output unit configured to output a wave-reception signal based on wave reception of an ultrasonic wave; and
an own-wave recognition unit configured to recognize an own wave which is a reflected wave of the wave transmission that may be included in the wave reception,
wherein
the wave-transmission signal generator is configured to generate the wave-transmission signal with a modulation pattern based on a true random number or a pseudo random number, and
the number of sections of the wave-transmission signal for each of which a frequency modulation pattern is individually settable in a time series is smaller than the number of bits of the true random number or the pseudo random number.

2. The signal processing device according to claim 1,
wherein
the wave-transmission signal generator is configured to generate the wave-transmission signal with a modulation pattern based on the pseudo random number.

3. The signal processing device according to claim 2, further comprising
an LFSR configured to generate the pseudo random number.

4. The signal processing device according to claim 3,
wherein
an initial value of the LFSR is part of a unique identification number assigned to the signal processing device.

5. The signal processing device according to claim 1,
wherein
the modulation pattern is configured by combining a plurality of modulation targets.

6. The signal processing device according to claim 1,
wherein
the own-wave recognition unit is configured to recognize the own wave by integrating a plurality of the wave-reception signals.

7. An ultrasonic system, comprising:
the signal processing device according to claim 1; and
an ultrasonic transmission reception device configured to be directly or indirectly connected to the signal processing device.

8. A vehicle, comprising the ultrasonic system according to claim 7.
